(19) United States
(12) Patent Application Publication
(10) Pub. No.: US 2013/0132953 A1
(43) Pub. Date: May 23, 2013

(54) Method and System for Providing Application by Virtual Machine and Computer-Readable Storage Medium to Execute the Method

(71) Applicants: Yu-Wei Chuang, Taichung City (TW); Feng-Cheng Lin, Taipei City (TW); Jui-Hao Sun, Pingtung City (TW)

(72) Inventors: Yu-Wei Chuang, Taichung City (TW); Feng-Cheng Lin, Taipei City (TW); Jui-Hao Sun, Pingtung City (TW)

(73) Assignee: INSTITUTE FOR INFORMATION INDUSTRY, Taipei (TW)

(21) Appl. No.: 13/437,095

(22) Filed: Apr. 2, 2012

(30) Foreign Application Priority Data
Nov. 21, 2011 (TW) 100142596

(51) Int. Cl. G06F 9/455

(52) U.S. Cl. 718/1

(57) ABSTRACT

In a method for providing an application by a virtual machine (VM), an application requesting instruction for requesting a target application is received from a client. An available VM is assigned according to the application requesting instruction. A target-application executable file corresponding to the target application is searched from several candidate executable files stored in an executable-file storage pool. The target-application executable file is mounted to the available VM. The mounted target-application executable file is executed through the available VM.

### RELATED APPLICATIONS

This application claims priority to Taiwan Application Serial Number 100142596, filed Nov. 21, 2011, which is herein incorporated by reference.

### BACKGROUND

1. Technical Field

The present invention relates to virtual machine (VM) technology. More particularly, the present invention relates to a system and a method for providing an application by a VM and a computer-readable storage medium to execute the method.

2. Description of Related Art

User interfaces have changed considerably over the years. In a previous time, command line interfaces, such as MS-DOS (Microsoft® Disk Operating System), provided command lines for users to input commands to execute corresponding applications. Subsequently, Graphical User Interfaces (GUIs) were developed to provide graphical icons for easy operation.

Recently, much attention has been given to concepts related to virtual machines (VMs). Users may initialize VMs and store their application programs or data on such VMs. In subsequence, users can access their VMs at any time, at any place and through any computer. Furthermore, users may also initialize several VMs in one physical computer to function as multiple computers, in which each VM is allocated with a different operating system (OS), is installed with one or more different application programs, provides a different operating environment, and stores different data.

When a user operates a VM, he/she can only execute application programs installed on the same. If a requested application program is not installed on the VM, the requested application program must be installed on the VM in the same manner as if operating a physical computer, and performing such installation is not convenient. Another way to provide the requested application program not installed on the VM is by initiating a new VM which is installed with the requested application program. However, it is time-consuming to initiate another new VM. In addition, the physical computer being used may not have image files for initiating a VM with the requested application program. Further, the physical computer may not have enough resources to initiate another new VM.

Such disadvantages may become worse when applied in the area of cloud computing since most cloud computing systems only store a few types of images for initiating VMs. Every user may have different needs. Hence, if cloud computing systems are designed to accommodate the needs of most users, VMs initiated by the cloud computing systems have to be installed with many application programs. However, each VM may consume many resources of a cloud computing system.

### SUMMARY

According to one embodiment of this invention, a method for providing an application by a virtual machine (VM) is provided to mount an executable file corresponding to an application, which a client requests, to a VM, such that the VM can execute the same. The method for providing an application by a VM performs the following operations:

(a) an application requesting instruction for requesting a target application is received from a client;

(b) an available VM is assigned according to the application requesting instruction;

(c) a target-application executable file corresponding to the target application is searched from several candidate executable files stored in an executable-file storage pool;

(d) the target-application executable file is mounted to the available VM; and

(e) the mounted target-application executable file is executed through the available VM.

According to another embodiment of this invention, a computer-readable storage medium is provided to store a computer program for executing the method for providing an application by a virtual machine above described above.

According to another embodiment of this invention, a system for providing an application by a VM is provided to mount an executable file corresponding to an application, which a client requests, to a VM, such that the VM can execute the same. The system for providing an application by a VM includes an executable-file storage pool, an instruction receiving module, a VM assigning module, an executable-file searching module and a mounting module. The executable-file storage pool stores several candidate executable files. The instruction receiving module receives an application requesting instruction for requesting a target application from a client. The VM assigning module assigns an available VM according to the application requesting instruction. The executable-file searching module searches a target-application executable file corresponding to the target application from the candidate executable files stored in the executable-file storage pool. The mounting module mounts the target-application executable file to the available VM, such that the available VM executes the mounted target-application executable file.

The present invention can achieve many advantages. When a user of the client wants to execute an application program, the presently available VM can be utilized for execution of the same. In addition, in one embodiment of this invention, even if no available VM is installed with the target application, the executable file corresponding to the same stored in the executable-file storage pool can be copied or linked for subsequent mounting, such that the VM without the target application pre-installed can in subsequence execute the target application. In other words, there is no need to initialize a new VM if no VM is installed with the target application. As a result, it is possible to install only a few applications in each VM, resulting in a reduction in the requested resource for each VM and the time for initializing a new VM. Furthermore, if several clients make a request for the same application, the same executable file corresponding to the requested application can be copied for subsequent mounting to provide to the clients. In other words, several different clients can utilize the same application at the same time.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for providing an application by a virtual machine (VM) according to one embodiment of this invention;

FIG. 2 illustrates a block diagram of a system for providing an application by a VM according to an embodiment of this invention; and

FIG. 3 illustrates a block diagram of a system for providing an application by a VM according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

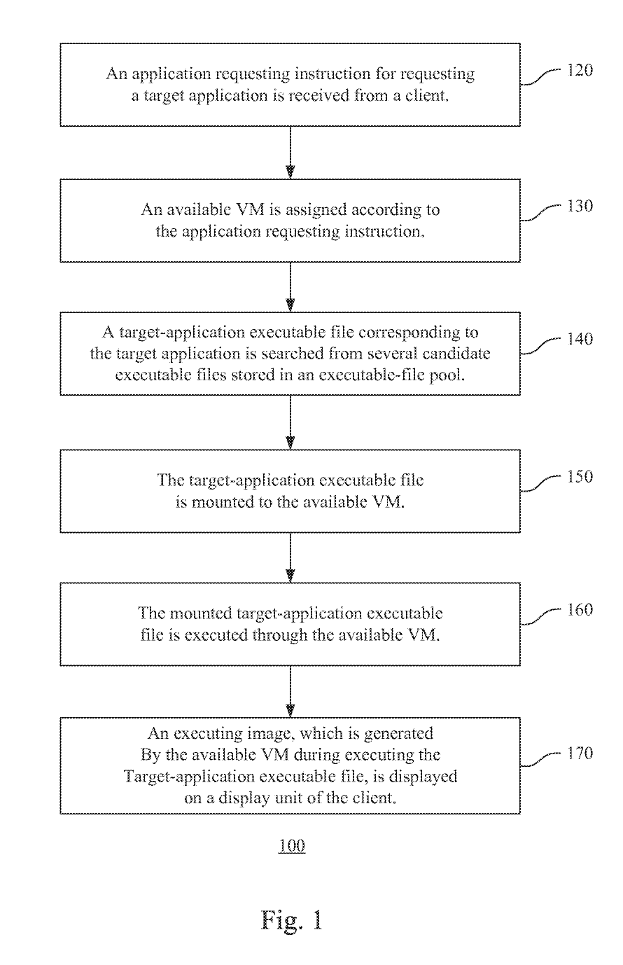

Referring to FIG. 1, a flow diagram will be described that illustrates a method for providing an application by a virtual machine (VM) according to one embodiment of this invention. In the method for providing an application by a VM, an executable file corresponding to an application, which a client requests, is mounted to a VM, such that the VM can execute the same. The method for providing an application by a VM may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The routine 100 of the method for providing an application by a VM starts at operation 120, where an application requesting instruction for requesting a target application is received from a client. In one embodiment of this invention, when a user of the client wants to execute a target application, the user of the client may operate an application program installed on the client to generate and transmit the application requesting instruction so that the same is received at operation 120. In another embodiment of this invention, a virtual desktop may be provided to the client, such that a user of the client can operate the provided virtual desktop to generate and transmit the application requesting instruction so that the same is received at operation 120. In still another embodiment of this invention, a web page may be provided to the client, such that a user of the client can use the provided web page to generate and transmit the application requesting instruction so that the same is received at operation 120.

In some embodiments, the client can build a connection to a system executing the method of the present application through a wired or wireless communication network. In some other embodiments, the client and a system executing the method of the present application can be disposed in the same hardware apparatus.

The routine 100 continues to operation 130, where an available VM is assigned according to the application requesting instruction.

In one embodiment of this application, the available VM may be a VM with an available resource to provide service to the client. In some embodiments, the application program corresponding to the application requesting instruction may or may not be installed in the available VM.

In one embodiment of this invention, several candidate VMs are provided, and each of the candidate VMs is allocated with a corresponding resource. Hence, in one embodiment at operation 130, the assignment is performed according to a result of determining if the corresponding resources of the candidate VMs are adequate for mounting and executing a target-application executable file. For example, at least one of the candidate VMs, which has a sufficient resource to mount and execute the target-application executable file, is selected as the available VM.

In another embodiment of this invention, each of the candidate VMs further includes an installed application. Hence, in some embodiments at operation 130, the assignment is performed according to a result of determining if the installed applications of the candidate VMs include the target application and if the corresponding resources of the candidate VMs are adequate for executing the target-application executable file. For example, the candidate VMs installed with the target application and with sufficient resources to execute the target-application executable file can be selected as the available VMs, and these candidate VMs can be given high priority. When all of the corresponding resources of the candidate VMs, the installed applications of which include the target application, are not adequate for executing the target-application executable file, the assigning at operation 130 is performed according to a result of determining if the corresponding resources of the candidate VMs, the installed applications of which do not comprise the target application, are adequate for executing the target-application executable file. In other words, one of the candidate VMs, the installed applications of which do not include the target application but have sufficient resources to execute the target-application executable file, is selected as the available VM.

Furthermore, a requested resource for the target application is determined according to the application requesting instruction at operation 130. The requested resource for the target application may include a requested computing resource, a requested memory space, a requested instruction set or any other requested resource for the target application. Hence, with such information of the requested resource for the target application, the available VM, which has a resource adequate for the requested resource, can be selected from the candidate VMs.

Moreover, a remaining resource of each of the candidate VMs can be monitored. Hence, in one embodiment at operation 130, one of the candidate VMs, the remaining resource of which is adequate for the requested resource, is selected as the available VM.

In subsequence, the routine 100 continues from operation 130 to operation 140, where a target-application executable file corresponding to the target application is searched from several candidate executable files stored in an executable-file storage pool. In one embodiment, the candidate executable files stored in the executable-file storage pool are executable within a VM environment of each of the candidate VMs, such that there is no need to re-install the candidate executable files according to the environment parameters of the candidate VMs.

In one embodiment of this invention, the candidate executable files stored in the executable-file storage pool can be executed directly within the VM system environments of the candidate VMs. In another embodiment of this invention, the candidate executable files stored in the executable-file storage pool can be executed within the VM system environments of the candidate VMs immediately after being compiled. In still another embodiment of this invention, the candidate executable files stored in the executable-file storage pool can be executed on an emulator for being executed directly within the VM system environments of the candidate VMs without being re-installed.

From operation 140, the routine 100 continues to operation 150, where the target-application executable file is mounted to the available VM assigned at operation 130. In one embodiment at operation 150, the target-application executable file may be copied or linked to a shared space. Subsequently, the target-application executable file in the shared space can be mounted to the available VM assigned at operation 130.

The routine 100 then continues to operation 160, where the mounted target-application executable file is executed through the available VM assigned at operation 130. Therefore, when a user of the client wants to execute an application program, the available VM can be utilized for execution of the same. In addition, in one embodiment of this invention, even if no available VM is installed with the target application, the executable file corresponding to the same stored in the executable-file storage pool can be copied or linked for subsequent mounting, such that the VM without the target application pre-installed can in subsequence execute the target application. In other words, there is no need to initialize a new VM if no VM is installed with the target application. As a result, it is possible to install only a few applications in each VM, resulting in a reduction in the requested resource for each VM and the time for initializing a new VM. Furthermore, if several clients make a request for the same application, the same executable file corresponding to the requested application can be copied for subsequent mounting to provide to the clients. In other words, several different clients can utilize the same application at the same time.

Subsequently, the routine 100 continues to operation 170, where an executing image, which is generated by the available VM during executing the target-application executable file, is displayed on a display unit of the client.

Moreover, in one embodiment of this invention, some executable files can be pre-mounted to the available VM. Hence, the routine 100 may perform operations, where several preset application executable files are mounted to the available VM when the available VM is initialized. Hence, before operation 150 is performed, it may be determined that if the preset application executable files mounted on the available VM include the target-application executable file. If the preset application executable files mounted on the available VM do not include the target-application executable file, operation 150 may be performed. If the preset application executable files mounted on the available VM include the target-application executable file, operation 150 may be skipped and operation 160 is performed subsequently. Therefore, by pre-mounting frequently-used executable files, the time for mounting may be further reduced.

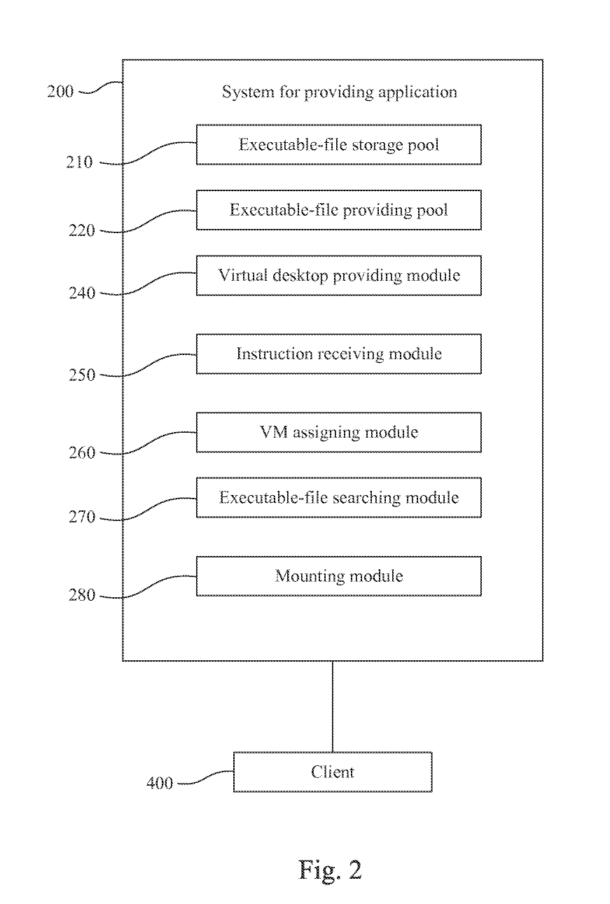

Referring to FIG. 2, a block diagram will be described that illustrates a system for providing an application by a VM according to an embodiment of this invention. The system mounts an executable file corresponding to an application, which a client requests, to a VM, such that the VM can execute the same.

The system 200 for providing an application by a VM includes an executable-file storage pool 210, an instruction receiving module 250, a VM assigning module 260, an executable-file searching module 270 and a mounting module 280. In one embodiment, the instruction receiving module 250, the VM assigning module 260, the executable-file searching module 270 and the mounting module 280 can be implemented by at least one processing unit of a single server. In another embodiment, the instruction receiving module 250, the VM assigning module 260, the executable-file searching module 270 and the mounting module 280 can be implemented discretely by processing units of several different servers.

The executable-file storage pool 210 stores several candidate executable files. In addition, the system 200 may further provide several initialized candidate VMs. In one embodiment of this invention, the executable-file storage pool 210 can be implemented by a storage unit of a server. In another embodiment of this invention, the executable-file storage pool 210 can be implemented by a cloud storage. In addition, the candidate executable files stored in the executable-file storage pool 210 fits the VM system environments of the candidate VMs, so that such candidate executable files do not have to re-install according to environment parameters of the candidate VMs. In one embodiment of this invention, the candidate executable files stored in the executable-file storage pool 210 can be executed directly within the VM system environments of the candidate VMs. In another embodiment of this invention, the candidate executable files stored in the executable-file storage pool 210 can be executed within the VM system environments of the candidate VMs immediately after being compiled. In still another embodiment of this invention, the candidate executable files stored in the executable-file storage pool 210 can be executed on an emulator for being executed directly within the VM system environments of the candidate VMs without being re-installed.

When a user of the client 400 requests a target application, the user of the client 400 may perform such an operation through the client 400 to generate a corresponding application requesting instruction. In subsequence, the instruction receiving module 250 receives an application requesting instruction for requesting the target application from the client 400. In one embodiment of this invention, when a user of the client 400 wants to execute the target application, the user of the client 400 may operate an application program installed on the client 400 to generate and transmit the application requesting instruction so that the same is received by the instruction receiving module 250. In another embodiment of this invention, a virtual desktop providing module 240 may provide a virtual desktop to the client 400. In subsequence, a user of the client 400 can operate the provided virtual desktop to generate and transmit the application requesting instruction so that the same is received by the instruction receiving module 250. The virtual desktop providing module 240 and the client 400 may be executed on the same electrical apparatus. Moreover, the virtual desktop providing module 240 may provide the virtual desktop remotely through a network to the client 400. The virtual desktop providing module 240 may utilize a Virtual Desktop Interface (VDI) to transmit images of the virtual desktop for providing the virtual desktop. Hence, a user of the client 400 can operate the virtual desktop displayed on the client 400. In still another embodiment of this invention, a web page may be provided to the client 400, such that a user of the client 400 can use the provided web page to generate and transmit the application requesting instruction so that the same is received by the instruction receiving module 250.

The VM assigning module 260 assigns an available VM according to the application requesting instruction. The system 200 may include several candidate VMs. Each of the candidate VMs is allocated with a corresponding resource. Hence, the VM assigning module 260 assigns the available VM according to a result of determining if the corresponding resources of the candidate VMs are adequate for mounting and executing the target-application executable file. Furthermore, each of the candidate VMs further includes an installed application. Hence, the VM assigning module 260 assigns the available VM according to a result of determining if the installed applications of the candidate VMs include the target application and if the corresponding resources of the candidate VMs are adequate for executing the target-application executable file. When all of the corresponding resources of the candidate VMs, the installed applications of which include the target application, are not adequate for executing the target-application executable file, the VM assigning module 260 assigns the available VM according to a result of determining if the corresponding resources of the candidate VMs, the installed applications of which do not include the target application, are adequate for executing the target-application executable file.

The executable-file searching module 270 searches a target-application executable file corresponding to the target application from the candidate executable files stored in the executable-file storage pool 210.

Subsequently, the mounting module 280 mounts the target-application executable file to the available VM. In one embodiment of this invention, the mounting module 280 may copy or link the target-application executable file from the executable-file storage pool 210 to a shared space of an executable-file providing pool 220 and instruct the available VM to mount target-application executable file in the shared space of the executable-file providing pool 220. Subsequently, the mounting module 280 can execute the mounted target-application executable file through the available VM. The executable-file storage pool 210 and the executable-file providing pool 220 may be allocated in the same hardware equipment or different equipment. In subsequence, the system 200 provides an executing image generated by the available VM during executing the target-application executable file, such that a display unit of the client 400 displays the executing image. Therefore, when a user of the client 400 wants to execute an application program, the available VM can be utilized for execution of the same. In addition, in one embodiment of this invention, even if no available VM is installed with the target application, the executable file corresponding to the same stored in the executable-file storage pool 210 can be copied or linked for subsequent mounting, such that the VM without the target application pre-installed can in subsequence execute the target application. In other words, there is no need to initialize a new VM if no VM is installed with the target application. As a result, it is possible to install only a few applications in each VM, resulting in a reduction in the requested resource for each VM and the time for initializing a new VM. Furthermore, if several clients make a request for the same application, the same executable file corresponding to the requested application can be copied for subsequent mounting to provide to the clients. In other words, several different clients can utilize the same application at the same time.

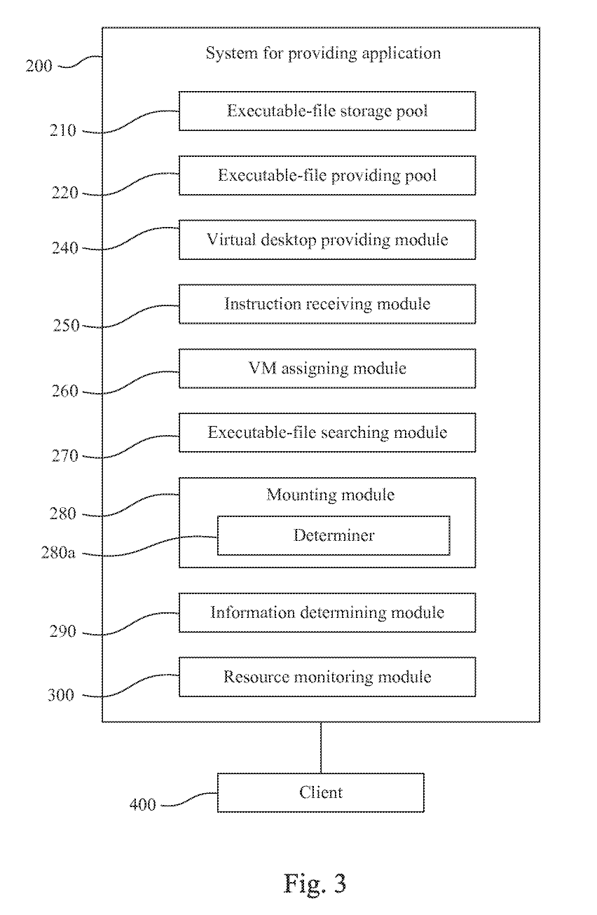

Referring to FIG. 3, a block diagram will be described that illustrates a system for providing an application by a VM according to another embodiment of this invention. It is to be understood that a description of elements identical to those mentioned above will not be repeated.

The system 200 may select a suitable VM for execution according to the requested resource to execute the application. Hence, the system 200 may further include an information determining module 290 for determining information about a requested resource for the target application according to the application requesting instruction. The requested resource for the target application may include a requested computing resource, a requested memory space, a requested instruction set or any other requested resource for the target application. In subsequence, the VM assigning module 260 selects one of the candidate VMs, which has a resource adequate for the requested resource, as the available VM. In addition, the system 200 may further include a resource monitoring module 300 for monitoring a remaining resource of each of the candidate VMs, such as a remaining computing resource, a remaining memory space or any other information about a remaining resource. Hence, the VM assigning module 260 selects one of the candidate VMs, the remaining resource of which is adequate for the requested resource, as the available VM.

In addition, the mounting module 280 may mount several preset application executable files to the available VM in advance. Hence, before mounting the target-application executable file to the available VM, a determiner 280a of the mounting module 280 may determine if the preset application executable files mounted on the available VM include the target-application executable file. If the preset application executable files mounted on the available VM do not include the target-application executable file, the mounting module 280 mounts the target-application executable file to the available VM. If the preset application executable files mounted on the available VM include the target-application executable file, the mounting module 280 does not further mount the target-application executable file to the available VM. Therefore, by pre-mounting frequently-used executable files, the time for mounting may be further reduced.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for providing an application by a virtual machine (VM) comprising:
(a) receiving an application requesting instruction for requesting a target application from a client;
(b) assigning an available VM according to the application requesting instruction;
(c) searching a target-application executable file corresponding to the target application from a plurality of candidate executable files stored in an executable-file storage pool;
(d) mounting the target-application executable file to the available VM; and
(e) executing the mounted target-application executable file through the available VM.

2. The method for providing an application by a VM of claim 1, wherein an application installed on the client generates and transmits the application requesting instruction, a virtual desktop is provided to the client to generate and transmit the application requesting instruction, or a web page is provided to the client to generate and transmit the application requesting instruction.

3. The method for providing an application by a VM of claim 1, further comprising:
providing a plurality of candidate VMs,
wherein each of the candidate VMs is allocated with a corresponding resource, and
wherein the assigning at operation (b) is performed according to a result of determining if the corresponding resources of the candidate VMs are adequate for mounting and executing the target-application executable file.

4. The method for providing an application by a VM of claim 3, wherein:
each of the candidate VMs further comprises an installed application;
the assigning at operation (b) is performed according to a result of determining if the installed applications of the candidate VMs comprise the target application and if the corresponding resources of the candidate VMs are adequate for executing the target-application executable file; and
when all of the corresponding resources of the candidate VMs, the installed applications of which comprise the target application, are not adequate for executing the target-application executable file, the assigning at operation (b) is performed according to a result of determining if the corresponding resources of the candidate VMs, the installed applications of which do not comprise the target application, are adequate for executing the target-application executable file.

5. The method for providing an application by a VM of claim 3, wherein the candidate executable files stored in the executable-file storage pool are executable within a VM environment of each of the candidate VMs.

6. The method for providing an application by a VM of claim 1 further comprising:
displaying an executing image generated by the available VM during executing the target-application executable file on a display unit of the client.

7. The method for providing an application by a VM of claim 1, wherein operation (b) comprises:
determining a requested resource for the target application according to the application requesting instruction; and
selecting the available VM, which has a resource adequate for the requested resource, from a plurality of candidate VMs.

8. The method for providing an application by a VM of claim 7 further comprising:
monitoring a remaining resource of each of the candidate VMs;
wherein selecting the available VM, which has the resource adequate for the requested resource, from the candidate VMs comprises:
selecting one of the candidate VMs, the remaining resource of which is adequate for the requested resource, as the available VM.

9. The method for providing an application by a VM of claim 1, wherein operation (d) comprises:
linking or copying the target-application executable file to a shared space from the executable-file storage pool; and
mounting the target-application executable file in the shared space.

10. The method for providing an application by a VM of claim 1, further comprising before operation (a):
mounting a plurality of preset application executable files to the available VM; and
determining if the preset application executable files comprise the target-application executable file;
wherein if the preset application executable files do not comprise the target-application executable file, operation (d) is performed; and
wherein if the preset application executable files comprise the target-application executable file, operation (d) is not performed.

11. A system for providing an application by a VM comprising:
an executable-file storage pool for storing a plurality of candidate executable files;
an instruction receiving module for receiving an application requesting instruction for requesting a target application from a client;
a VM assigning module for assigning an available VM according to the application requesting instruction;
an executable-file searching module for searching a target-application executable file corresponding to the target application from the candidate executable files stored in the executable-file storage pool; and
a mounting module for mounting the target-application executable file to the available VM, such that the available VM executes the mounted target-application executable file.

12. The system for providing an application by a VM of claim 11, wherein an application installed on the client generates and transmits the application requesting instruction, a virtual desktop is provided to the client to generate and transmit the application requesting instruction, or a web page is provided to the client to generate and transmit the application requesting instruction.

13. The system for providing an application by a VM of claim 11, further comprising:
a plurality of candidate VMs, wherein each of the candidate VMs is allocated with a corresponding resource;
wherein the VM assigning module assigns the available VM according to a result of determining if the corresponding resources of the candidate VMs are adequate for mounting and executing the target-application executable file.

14. The system for providing an application by a VM of claim 13, wherein:
each of the candidate VMs further comprises an installed application;
the VM assigning module assigns the available VM according to a result of determining if the installed applications of the candidate VMs comprise the target application and if the corresponding resources of the candidate VMs are adequate for executing the target-application executable file; and
when all of the corresponding resources of the candidate VMs, the installed applications of which comprise the target application, are not adequate for executing the target-application executable file, the VM assigning module assigns the available VM according to a result of determining if the corresponding resources of the candidate VMs, the installed applications of which do not comprise the target application, are adequate for executing the target-application executable file.

15. The system for providing an application by a VM of claim 11, wherein the mounting module provides an executing image generated by the available VM during executing the target-application executable file, such that a display unit of the client displays the executing image.

16. The system for providing an application by a VM of claim 11, further comprising:
an information determining module for determining a requested resource for the target application according to the application requesting instruction;
wherein the VM assigning module selects one of the candidate VMs, which has a resource adequate for the requested resource, as the available VM.

17. The system for providing an application by a VM of claim 16 further comprising:
a resource monitoring module for monitoring a remaining resource of each of the candidate VMs;
wherein the VM assigning module selects one of the candidate VMs, the remaining resource of which is adequate for the requested resource, as the available VM.

18. The system for providing an application by a VM of claim 11, wherein the mounting module further mounts a plurality of preset application executable files to the available VM, wherein before mounting the target-application executable file to the available VM, the mounting module further determines if the preset application executable files comprise the target-application executable file;
wherein if the preset application executable files do not comprise the target-application executable file, the mounting module mounts the target-application executable file to the available VM.

19. A computer-readable storage medium with a computer program to execute a method for providing an application by a VM, wherein the method comprises:
(a) receiving an application requesting instruction for requesting a target application from a client;
(b) assigning an available VM according to the application requesting instruction;
(c) searching a target-application executable file corresponding to the target application from a plurality of candidate executable files stored in an executable-file storage pool;
(d) mounting the target-application executable file to the available VM; and
(e) executing the mounted target-application executable file through the available VM.

20. The computer-readable storage medium of claim 19, wherein the method further comprises before operation (a):
mounting a plurality of preset application executable files to the available VM; and
determining if the preset application executable files comprise the target-application executable file;
wherein if the preset application executable files do not comprise the target-application executable file, operation (d) is performed; and
wherein if the preset application executable files comprise the target-application executable file, operation (d) is not performed.
